(19) United States
(12) Patent Application Publication
(10) Pub. No.: US 2024/0234744 A9
(43) Pub. Date: Jul. 11, 2024

(54) CURRENT COLLECTORS COMPRISING METAL GRIDS AND METHODS OF FABRICATION THEREOF

(71) Applicant: Cuberg, Inc., San Leandro, CA (US)

(72) Inventors: Edward Meyjes, Berkeley, CA (US); Katherine Hanus, San Francisco, CA (US); Raven Barnes, Oakland, CA (US); David Britt, El Cerrito, CA (US)

(73) Assignee: Cuberg, Inc., San Leandro, CA (US)

(21) Appl. No.: 18/491,939

(22) Filed: Oct. 23, 2023

Related U.S. Application Data
(60) Provisional application No. 63/380,545, filed on Oct. 21, 2022.

(51) Int. Cl. H01M 4/72; H01M 4/134; H01M 4/38; H01M 4/66

(52) U.S. Cl. CPC H01M 4/72; H01M 4/134; H01M 4/382; H01M 4/661; H01M 4/667; H01M 4/669; H01M 2004/027

(57) ABSTRACT

Described herein are current collectors comprising metal grids as well as electrodes and lithium-metal cells comprising such current collectors and methods of fabricating such current collectors, electrodes, and lithium-metal cells. A thin current collector comprises a polymer base and a metal layer positioned on, directly interfaces, and supported by one side of the polymer base. A thin current collector also comprises a metal grid, which directly interfaces and is supported by the edge of the polymer base. The metal grid is electrically coupled to the metal layer, e.g., by overlapping or at least forming an interface with the metal layer. In an electrode that further comprises an active material layer supported on the metal layer, the metal grid extends away from the active material layer. In an electrochemical cell, the metal grid can be connected to the metal grids of other electrodes and/or cell tabs.

### CROSS-REFERENCE TO RELATED APPLICATIONS

This application claims the benefit under 35 U.S.C. § 119(e) of U.S. Provisional Patent Application 63/380,545, filed on 2022 Oct. 21, which is incorporated herein by reference in its entirety for all purposes.

### BACKGROUND

Convention lithium-metal and lithium-ion cells utilize current collectors in the form of metal foils. For example, a positive electrode may be fabricated with an aluminum foil that supports one or two positive active material layers. Metal foils provide mechanical support and electrical conductivity between the active material layers (supported by the foils) and other components of the cell, e.g., an electrode tab that can be welded to the foil. However, only a portion of the total thickness is typically needed for electrical conductivity (even for high-rate applications). The remaining thickness is needed for handling current collectors as standalone structures, e.g., rewinding, deposting active material layers, etc. However, metals are significantly heavier than other materials (e.g., polymers) that are capable of providing the same level of mechanical support. At the same time, these other materials may not be electrically conductive.

Furthermore, excessing thickness (from the electrical conductivity standpoint) is less desirable from safety considerations. For example, lithium dendrite growth can cause a local short circuit between the electrodes while the current collectors provide the electrical pathways to this short circuit. If the current (through one or both current collectors) is not cut to this short circuit, then a more severe thermal event can develop leading to potentially more dangerous conditions in the cell.

One option to mitigate such shorts is to use a polymer base as a part of a current collector. Specifically, a combination of a polymer base and metal layers supported on the polymer base can be used to replace a metal foil. The polymer base provides mechanical support while the metal layers are used for electrical conductivity to and from the active material layers disposed over these metal layers. Unlike metals, polymers have low melting points and would melt at the area of a short circuit of one develops.

However, introducing polymer bases interferes with conventional processing of the current collectors, in particular with the ability to form electrical connections between the current collectors and other components, such as cell tabs. For example, a portion of the current can extend beyond the active material layers and used as electrode tabs. These tabs needs to be interconnected and/or connected to a cell tab. Various forms of welding (e.g., ultrasonic, resistance, and laser) that are conventionally used for connecting foils to electrode tabs may not suitable when current collectors are formed with polymer bases.

What is needed are new current collectors comprising metal grids as well as electrodes and lithium-metal cells comprising such current collectors and methods of fabricating such current collectors, electrodes, and lithium-metal cells

### SUMMARY

Described herein are current collectors comprising metal grids as well as electrodes and lithium-metal cells comprising such current collectors and methods of fabricating such current collectors, electrodes, and lithium-metal cells. A thin current collector comprises a polymer base and a metal layer positioned on, directly interfaces, and supported by one side of the polymer base. A thin current collector also comprises a metal grid, which directly interfaces and is supported by the edge of the polymer base. The metal grid is electrically coupled to the metal layer, e.g., by overlapping or at least forming an interface with the metal layer. In an electrode that further comprises an active material layer supported on the metal layer, the metal grid extends away from the active material layer. In an electrochemical cell, the metal grid can be connected to the metal grids of other electrodes and/or cell tabs.

Clause 1. An electrochemical cell comprising: an electrode comprising a current collector and an active material layer, wherein: the current collector comprises a polymer base comprising a first side, a second side, and a third side, the first side is opposite the second side and separated from the second side by a thickness of the polymer base, the third side extends between the first side and the second side along the thickness of the polymer base, the current collector further comprises a metal layer disposed on and supported by the first side of the polymer base, the metal layer has a thickness smaller than the thickness of the polymer base, the metal layer is positioned between and directly interfaces both the polymer base and the active material layer, the current collector further comprising a metal grid directly interfacing and supported by the third side of the polymer base thereby forming a polymer base-grid interface with the polymer base, and the metal grid is electrically coupled to the metal layer and extends away from the active material layer.

Clause 2. The electrochemical cell of clause 1, wherein the electrochemical cell is a lithium metal cell.

Clause 3. The electrochemical cell of clause 1, wherein: the electrode is a positive electrode, and the active material layer is a positive active material layer comprising positive active material structures and a positive polymer active layer binder.

Clause 4. The electrochemical cell of clause 3, wherein the metal layer is a positive metal layer comprising aluminum.

Clause 5. The electrochemical cell of clause 1, wherein: the electrode is a negative electrode, and the active material layer is a negative active material layer comprising lithium metal.

Clause 6. The electrochemical cell of clause 5, wherein the metal layer comprises one or more lithium, copper, steel, and nickel.

Clause 7. The electrochemical cell of clause 1, wherein the thickness of the metal layer is at least 5 times smaller than the thickness of the polymer base.

Clause 8. The electrochemical cell of clause 1, wherein: the thickness of the metal layer is less than 2 micrometers, and the thickness of the polymer base is at least 5 micrometers.

Clause 9. The electrochemical cell of clause 1, wherein the composition of the metal layer and the composition of the metal grid is substantially similar.

Clause 10. The electrochemical cell of clause 1, wherein the composition of the metal layer and the composition of the metal grid is different.

Clause 11. The electrochemical cell of clause 1, wherein: the metal layer comprises aluminum, and the metal grid comprises nickel.

Clause 12. The electrochemical cell of clause 1, wherein at least one of the metal layer and the metal grid comprises at least one of aluminum, copper, nickel, titanium, steel, and silver.

Clause 13. The electrochemical cell of clause 1, wherein the polymer base comprises polyethylene terephthalate, polypropylene, polycarbonate, polyethylene, polyimide, ceramic-based polymer, cellulose, nylon, and various polyolefins.

Clause 14. The electrochemical cell of clause 1, wherein the metal layer and the metal grid form a metal layer-grid interface corresponding to a thickness of the metal layer.

Clause 15. The electrochemical cell of clause 14, wherein at least one surface of the metal layer is coplanar with at least one surface of the metal grid.

Clause 16. The electrochemical cell of clause 14, wherein the metal layer-grid interface is formed by a weld seam.

Clause 17. The electrochemical cell of clause 14, wherein the metal layer-grid interface is aligned with the polymer base-grid interface.

Clause 18. The electrochemical cell of clause 1, wherein the metal layer extends past the third side of the polymer base and overlaps with the metal grid forming a meta layer-grid interface.

Clause 19. The electrochemical cell of clause 18, wherein the metal layer-grid interface is substantially perpendicular to the polymer base-grid interface.

Clause 20. The electrochemical cell of clause 1, wherein the meta layer-grid interface extends along at least a portion of a length of the metal grid.

Clause 21. The electrochemical cell of clause 1, wherein the meta layer-grid interface forms by sputtering, soldering, or cathodic-arc depositing the metal layer over the metal grid.

Clause 22. The electrochemical cell of clause 1, wherein the metal grid comprises a pin protruding into the polymer base past the third side.

Clause 23. The electrochemical cell of clause 22, wherein the pin protrudes into the polymer base parallel to the metal layer.

Clause 24. The electrochemical cell of clause 1, wherein the metal grid protrudes past an exterior surface of the metal layer that faces away from the polymer base.

Clause 25. The electrochemical cell of clause 24, wherein a height (H) of the metal grid protruding past the exterior surface of the metal layer is at least 1 micrometer.

Clause 26. The electrochemical cell of clause 24, wherein the metal grid is formed by sputtering, soldering, ultrasonic soldering, or electroplating.

Clause 27. The electrochemical cell of clause 1, further comprising an additional active material layer, wherein: the current collector further comprises an additional metal layer disposed on and supported by the second side of the polymer base, the additional metal layer is positioned between and directly interfaces both the polymer base and the additional active material layer, and the metal grid is electrically coupled to the additional metal layer and extends away from the additional active material layer.

Clause 28. The electrochemical cell of clause 27, wherein the thickness of a stack comprising the metal layer, the polymer base, and the additional metal layer is equal to the thickness of the metal grid.

Clause 29. A current collector comprising: a polymer base comprising a first side, a second side, and a third side, wherein the first side is opposite the second side and separated from the second side by a thickness of the polymer base, and wherein the third side extends between the first side and the second side along the thickness of the polymer base; a metal layer disposed on, directly interfaces, and supported by the first side of the polymer base, wherein the metal layer has a thickness smaller than the thickness of the polymer base; and a metal grid directly interfacing and supported by the third side of the polymer base thereby forming a polymer base-grid interface with the polymer base, wherein the metal grid is electrically coupled to the metal layer.

Clause 30. A method comprising: providing a polymer base comprising a first side, a second side, and a third side, wherein the first side is opposite the second side and separated from the second side by a thickness of the polymer base, and wherein the third side extends between the first side and the second side along the thickness of the polymer base, depositing a metal layer on the first side of the polymer base, wherein the metal layer has a thickness smaller than the thickness of the polymer base; and attaching a metal grid to the third side of the polymer base thereby forming a polymer base-grid interface with the polymer base, wherein the metal grid is electrically coupled to the metal layer.

Clause 31. The method of clause 30, wherein depositing the metal layer comprises puttering, soldering, ultrasonic soldering, or electroplating.

Clause 32. The method of clause 30, wherein attaching the metal grid comprises at least one of: welding the metal grid to the polymer base, adhering the metal grid to the polymer base, inserting a portion of the metal grid into the polymer base, and overlapping a portion of the metal layer with the metal grid.

Clause 33. The method of clause 30, wherein welding the metal grid to the polymer base comprises one of ultrasonic welding, ultrasonic soldering, laser welding, or heat sealing.

Clause 34. The method of clause 30, wherein the metal layer is deposited before attaching the metal grid.

Clause 35. The method of clause 34, wherein attaching the metal grid further comprising welding the metal grid to the metal layer.

Clause 36. The method of clause 30, wherein the metal grid is attached before depositing the metal layer.

Clause 37. The method of clause 36, wherein the metal layer at least partially overlaps with the metal grid.

These and other embodiments are described further below with reference to the figures.

### BRIEF DESCRIPTION OF THE DRAWINGS

FIG. 1A is a schematic cross-sectional side view of an electrochemical cell formed by stacking positive and negative electrodes and interconnecting their respective metal grids, in accordance with some examples.

FIG. 1B is a schematic cross-sectional view of a part of a positive electrode illustrating different electrode components, in accordance with some examples.

FIG. 1C is a schematic cross-sectional view of a part of a negative electrode illustrating different electrode components, in accordance with some examples.

FIG. 1D is a schematic cross-sectional view of a part of a general one-sided electrode illustrating different electrode components, in accordance with some examples.

FIG. 1E is a schematic cross-sectional view of a part of a general two-sided electrode illustrating different electrode components, in accordance with some examples.

FIG. 2 is a block diagram of a lithium-metal cell illustrating different cell components, in accordance with some examples.

FIGS. 3A-3F are schematic cross-sectional views of different examples of general electrodes, having different types of metal grids.

FIG. 4 is a process flowchart corresponding to a method of forming an electrode stack, such as the electrode stack in FIG. 1A, in accordance with some examples.

FIGS. 5A-5B are different stages during the fabrication of an electrode comprising a metal grid, in accordance with some examples.

FIG. 6 is a block diagram of an electric vehicle comprising one or more electrochemical cells, described herein.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

### INTRODUCTION

As noted above, a polymer base can be used as a part of a current collector to mitigate local shorts and to reduce the overall weight of the current collector. Specifically, polymer bases can be operable as fuses, isolating specific areas in an electrode that have experienced short circuits, while the rest of the electrode continues to function. This functionality may be referred to as localized electrode fusing. An additional benefit of polymer bases (instead of metal foils) is weight saving. Specifically, metals are substantially heavier than polymers as shown in the following table comparing the specific gravities of different materials.

| Material | Specific Gravity |
|---|---|
| Aluminum | 2.55-2.80 |
| Copper | 8.8-8.95 |
| Polyethylene Terephthalate (PET) | 1.34 |

As such, replacing most or all metal current collectors with polymer bases provides substantial weight savings thereby potentially increasing the gravimetric capacity of an electrochemical cell as well as improving cell safety.

However, forming electrical connections (e.g., by welding) to a current collector comprising a polymer base is challenging. The polymer base interferes with forming a metal weld nugget by being closely positioned to the weld zone or even being positioned along the path of weld tools. To address this issue, a current collector is equipped with a metal grid that is supported by a polymer base but also extends away from the polymer base. The metal grid is electrically connected to a metal layer that is positioned on the polymer base and that interfaces with the cell's active layer. The metal grid can be connected to one or more other metal grids and/or other components of the cell (e.g., a cell tab extending to a cell terminal).

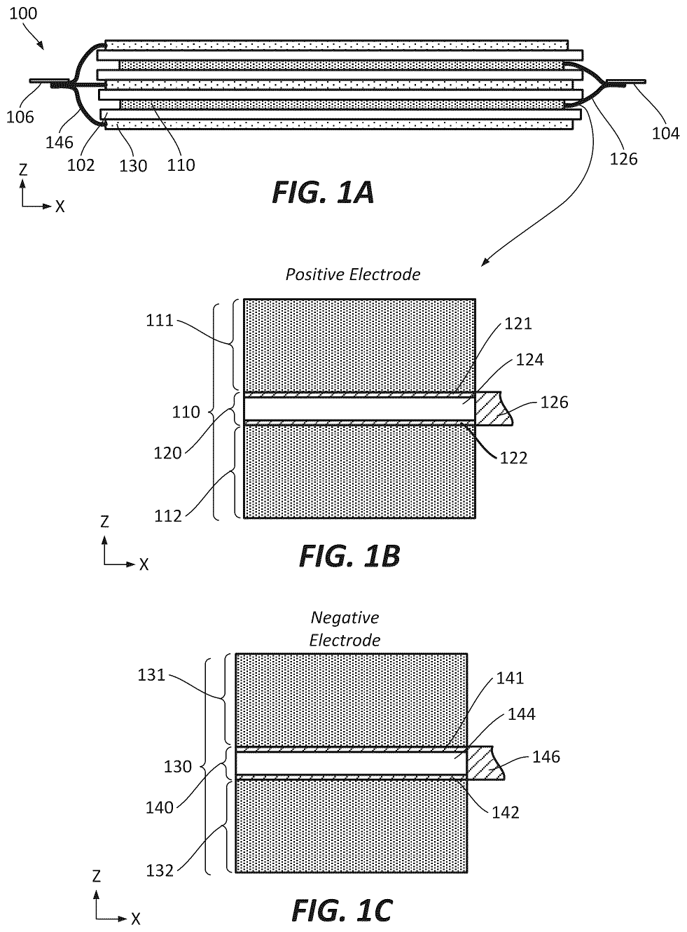

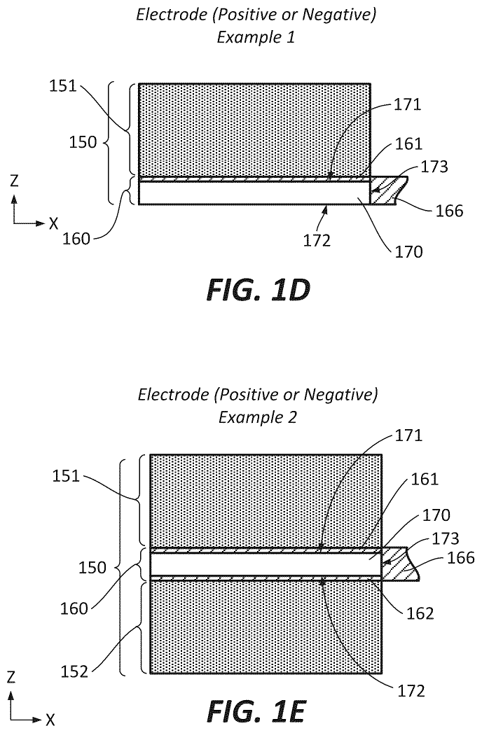

FIG. 1A is a schematic cross-sectional side view of electrochemical cell 100 formed by stacking positive electrodes 110 and negative electrodes 130 and interconnecting their respective metal grids, in accordance with some examples. Specifically, each positive electrode 110 comprises positive metal grid 126 that extends and is connected to positive metal grids 126 of other positive electrodes 110 as well as positive cell tab 104. Similarly, each negative electrode 130 comprises negative metal grid 146 that extends and is connected to negative metal grids 126 of other negative electrodes 130 as well as negative cell tab 106. These positive metal grids 126 and negative metal grids 146 may be also referred to as electrode tabs and may be used for connecting to cell tabs. Separator 102 is positioned between each adjacent pair of positive electrodes 110 and negative electrodes 130 and provides electronic isolation. While FIG. 1A illustrates positive electrodes 110 comprising positive metal grids 126 and, separately, negative electrodes 130 comprising negative metal grids 146, other examples, in which only one type of electrodes (e.g., positive electrodes 110 or negative electrodes 130) comprise metal grids are also within the scope.

FIG. 1B is a schematic cross-sectional view of a part of positive electrode 110 illustrating different electrode components, in accordance with some examples. Specifically, positive electrode 110 comprises positive active material layer 111, additional positive active material layer 112, and positive current collector 120 positioned between these active material layers. Positive current collector 120 comprises positive metal layer 121, additional positive metal layer 122, and positive polymer base 124 positioned between these metal layers. Positive metal layer 121 interfaces positive active material layer 111, while additional positive metal layer 122 interfaces additional positive active material layer 112. Positive current collector 120 also comprises positive metal grid 126, supported (at least in part) by positive polymer base 124.

FIG. 1C is a schematic cross-sectional view of a part of negative electrode 130, which has a similar structure to positive electrode 110 described above with reference to FIG. 1B. Specifically, negative electrode 130 comprises negative active material layer 131, additional negative active material layer 132, and negative current collector 140 positioned between these active material layers. Negative current collector 140 comprises negative metal layer 141, additional negative metal layer 142, and negative polymer base 144 positioned between these metal layers. Negative metal layer 141 interfaces negative active material layer 131, while additional negative metal layer 142 interfaces additional negative active material layer 132. Negative current collector 140 also comprises negative metal grid 146, supported (at least in part) by negative polymer base 144.

In some examples, the negative active material layer 131 further comprises negative active material structures 134 (e.g., a lithium metal layer, graphite/silicon active material structures/particles). In more specific examples (e.g., lithium ion cells), the negative active material layer 131 may further comprise a negative active layer polymer binder 136 and/or a negative active layer conductive additive 138.

Electrochemical cell 100 is a lithium metal cell, in which case negative active material layer 131 and additional negative active material layer 132 comprise or are formed substantially from lithium metal. However, other types of cells (e.g., lithium-ion cells) are within the scope.

FIGS. 1D and 1E illustrate examples of an electrode 150, which can be either a positive electrode or a negative electrode.

### Electrochemical Cell Examples

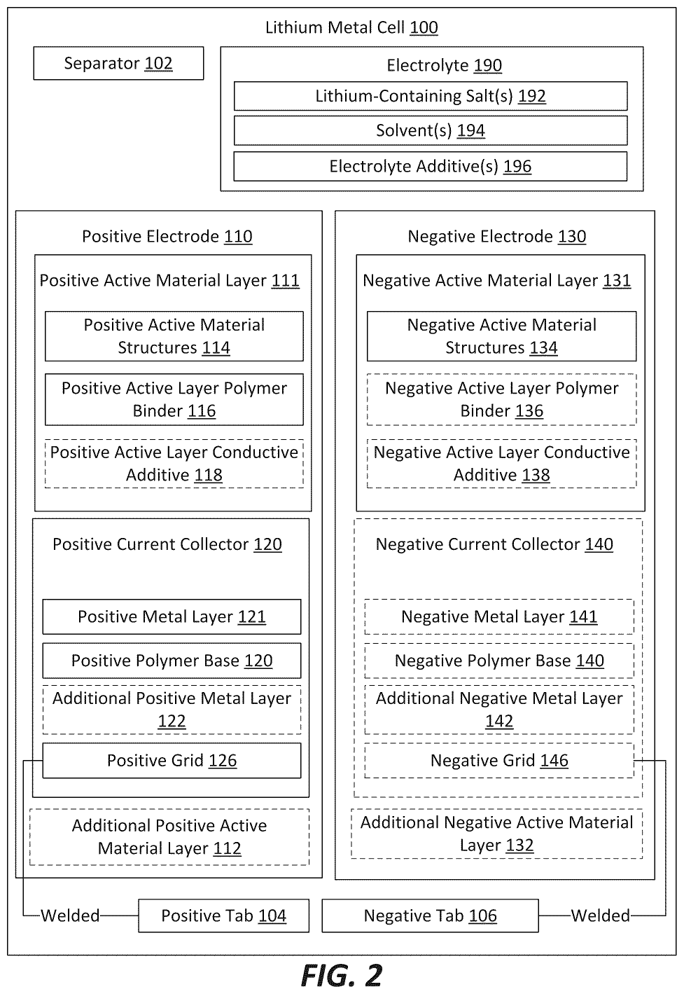

Additional components of electrochemical cell 100 are presented in FIG. 2. For example, positive active material layer 111 (and, when present, additional positive active material layer 112) can comprise positive active material structures 114 and positive polymer active layer binder 116 (and a positive active layer condictive additive 118, in more specific examples). In this example, positive metal layer 121 (and, when present, additional positive metal layer 122) can comprise aluminum. Similarly, positive metal grid 126 can be formed from aluminum.

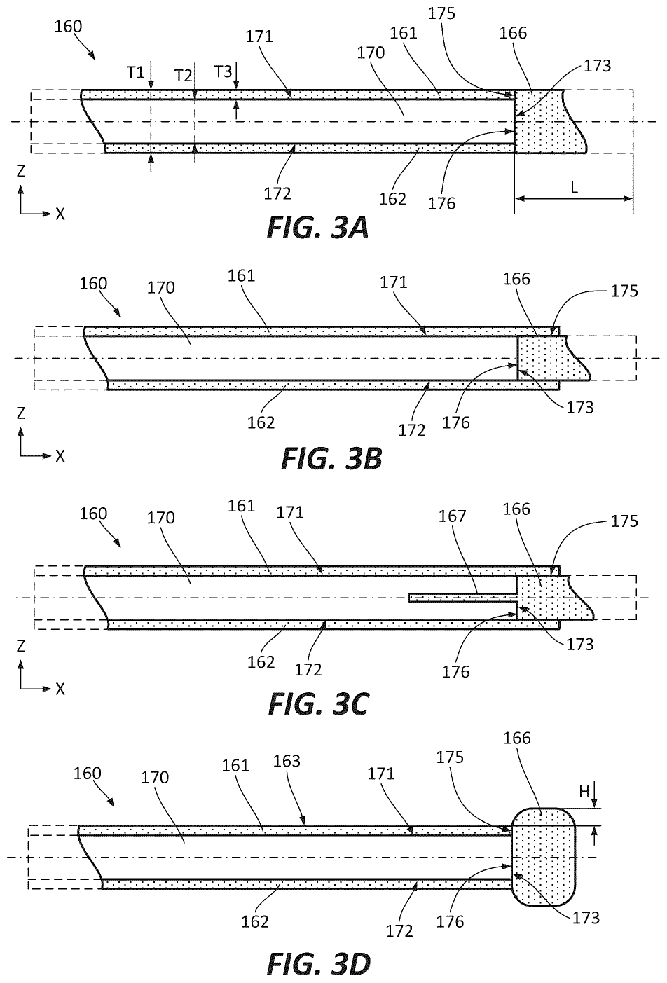

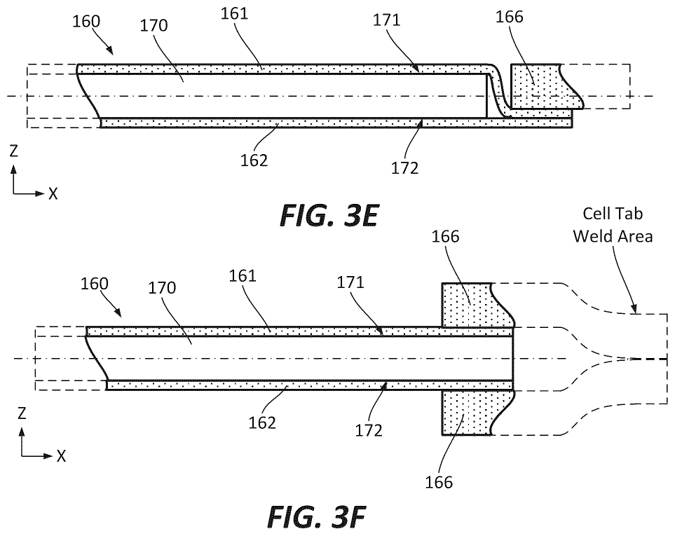

Additional features of positive electrode 110 (comprising positive metal grid 126) and negative electrode 130 (comprising negative metal grid 146) will now be described with reference to FIGS. 1D and 1E as well as FIGS. 3A-3F, which are directed to general electrode 150. In other words, electrode 150 can represent either positive electrode 130 or negative electrode 150. One having ordinary skill in the art would understand that various components (e.g., the composition of metal components and active material layers) will be different for positive electrode 130 and negative electrode 150.

Referring to FIGS. 1D and 1E, in some examples, electrochemical cell 100 comprises electrode 150, which may be referred to as a general electrode and which can be either positive electrode 110 or negative electrode 130 described above. Electrode 150 comprises current collector 160 and active material layer 151. When electrode 150 is a one-sided electrode as shown in FIG. 1D, active material layer 151 is the only active material layer and one side of current collector 160 is exposed. Alternatively, when electrode 150 is a two-sided electrode as shown in FIG. 1E, electrode 150 further comprises additional active material layer 152 such that current collector 160 is positioned between active material layer 151 and additional active material layer 152. The composition of active material layer 151 (and additional active material layer 152, if one is present) depends on the type of electrode 150 (e.g., positive electrode or negative electrode).

Current collector 160 comprises polymer base 170 comprising first side 171, second side 172, and third side 173. First side 171 is opposite second side 172 and separated from second side 172 by the thickness of polymer base 170. For example, the thickness of polymer base 170 can be at least 5 micrometers or, more specifically, at least 10 micrometers. Third side 173 extends between first side 171 and second side 172 along the thickness of polymer base 170 and may be referred to as an edge of polymer base 170

Referring to FIGS. 1D and 1E, current collector 160 further comprises metal layer 161 disposed on and supported by first side 171 of polymer base 170. When electrode 150 is a one-sided electrode as shown in FIG. 1D, metal layer 161 is the only metal layer and one side of polymer base 170 is exposed. Alternatively, when electrode 150 is a two-sided electrode as shown in FIG. 1E, electrode 150 further comprises additional metal layer 162 such that polymer base 170 is positioned between metal layer 161 and additional metal layer 162.

Metal layer 161 is positioned between and directly interfaces both polymer base 170 and active material layer 151. Specifically, metal layer 161 is used for electronic conductivity between active material layer 151 and various other components of electrode 150. In some examples, when the material of active material layer 151 is sufficiently conductive (e.g., lithium metal), active material layer 151 and metal layer 161 can have the composition and form the same monolythic structure. A portion of this structure can be used as active material layer 151 (e.g., a portion of lithium metal that is transferred to the positive electrode during the discharge) and another portion remains as metal layer 161. The remaining metal layer 161 effectively serves as a seed for the later deposition of active material layer 151 (during the charge).

In some examples, metal layer 161 has a thickness smaller than the thickness of polymer base 170, e.g., at least 2 times smaller, 5 times smaller, or even 10 times smaller. As such, polymer base 170 can provide the bulk of mechanical support to current collector 160.

For example, the thickness of metal layer 161 is less than 5 micrometers, less than 2 micrometers or even less than 1 micrometer. The thickness of metal layer 161 can be selected based on the electronic conductivity of the materials forming metal layer 161, the size of metal layer 161 (the electron travel distance), and the current carrying capabilities required from metal layer 161 (e.g., thicker metal layers for higher-current applications).

In the same other examples, the thickness of polymer base 170 is at least 5 micrometers, at least about 10 micrometers, or even at least about 15 micrometers. This thickness depends on the material of polymer base 170, the required mechanical support capabilities required from polymer base 170, and the required short-circuit fusing capabilities of polymer base 170.

Current collector 160 further comprises metal grid 166 directly interfacing and supported by third side 173 of polymer base 170 thereby forming polymer base-grid interface 176 with polymer base 170. Metal grid 166 is electrically coupled to metal layer 161 and extends away from active material layer 151. In other words, metal grid 166 does not overlap with active material layer 151, at least in the manner of metal layer 161 which is substantially covered by active material layer 151 in electrode 150. In some examples, most of metal grid 166 does not overlap with active material layer 151. In more specific examples, no portion of metal grid 166 overlaps with active material layer 151.

Various examples of materials suitable for metal grid 166 or metal layer 161 are within the scope such as aluminum, copper, nickel, titanium, steel, and silver. Another example of the material for metal layer 161 is lithium (e.g., when a lithium metal layer is formed directly over polymer base 170).

In some examples, the composition of metal layer 161 and the composition of metal grid 166 is the same or at least substantially similar (e.g., compositional variations are less than 10% by weight). The similarity of the materials can help to join the two components, e.g., by welding, soldering, or other techniques further described below.

In some examples, the composition of metal layer 161 and the composition of metal grid 166 are different. For example, metal layer 161 can be formed from aluminum while metal grid 166 can be formed from nickel.

In some examples, polymer base 170 comprises one or more polyethylene terephthalate, polypropylene, polycarbonate, polyethylene, polyimide (e.g., KAPTON®), ceramic-based polymer, cellulose, nylon, and various polyolefins. A material for polymer base 170 can be selected to ensure shrinkage during heating (e.g., during a local short), which pulls the corresponding portion of metal layer 161 (supported by polymer base 170) from that local short. In other words, in some examples, the material of polymer base 170 shrinks upon heating.

Various forms of integration of metal grid 166 to current collector 160 will now be described with reference to FIGS. 3A-3D. Referring to FIG. 3A, in some examples, metal layer 161 and metal grid 166 form metal layer-grid interface 175 corresponding to the thickness of metal layer 161. As such, at least one surface of metal layer 161 is coplanar with at least one surface of metal grid 166. When additional metal layer 162 is present, this additional metal layer 162 may form a similar interface and be co-planar with the other surface of metal grid 166. This interface/co-planar feature can be used to form electrical and mechanical connections between metal layer 161 and metal grid 166. Specifically, metal layer-grid interface 175 is formed by a weld seam (e.g., a laser-weld seam or a solder seam).

It should be noted that additional mechanical support to metal grid 166 is provided by polymer base 170, e.g., through polymer base-grid interface 176. This polymer base-grid interface 176 can be formed by various means, e.g., thermal welding, adhesive, and the like.

Additional components of electrochemical cells 100 include electrolyte 190, which can comprise one or more lithium-containing salts 192, one or more solvents 194, and one or more electrolyte additives 196.

### Metal Grid Examples

Referring to FIG. 3A, in some examples, metal layer-grid interface 175 is aligned with polymer base-grid interface 176. More specifically, metal layer-grid interface 175 is colinear with polymer base-grid interface 176. This approach allows using metal grid 166 with a straight edge to form metal layer-grid interface 175 polymer base-grid interface 176.

Referring to FIG. 3B, in some examples, metal layer 161 extends past third side 173 of polymer base 170 and overlaps with metal grid 166 forming meta layer-grid interface 175. In these examples, metal layer-grid interface 175 is substantially perpendicular to polymer base-grid interface 176. For example, meta layer-grid interface 175 extends along at least a portion of the length of metal grid 166. As such, the area of meta layer-grid interface 175 in these examples can be larger than that in FIG. 3A thereby enhancing the electrical conductivity and mechanical support provided by polymer base-grid interface 176. In some examples, meta layer-grid interface 175 forms by sputtering metal layer 161 over metal grid 166. Other methods include soldering and cathodic-arc deposition.

Referring to FIG. 3C, in some examples, metal grid 166 comprises pin 167 protruding into polymer base 170 past third side 173. Pin 167 can be used to enhance the mechanical support by extending polymer base-grid interface 176. In these examples, polymer base-grid interface 176 extends in multiple directions (e.g., along the Z-axis and along the X-axis). For example, pin 167 can protrude into polymer base 170 parallel to metal layer 161.

In some examples, pin 167 is monolithic with the rest of metal grid 166. Alternatively, pin 167 and the rest of metal grid 166 are separate components (e.g., made from different materials) that are joined together. In some examples, pin 167 interfaces metal layer 161.

Referring to FIG. 3D, in some examples, metal grid 166 protrudes past exterior surface 163 of metal layer 161 that faces away from polymer base 170. For example, the height (H) of this protrusion can be used to accommodate other components of the stack (e.g., separators and other electrodes), e.g. by compensating the thickness of these other components. For example, the protrusion height can be equal to the combined thickness of two electrode layers and one electrode (of the opposite type), e.g., to make a direct connection with another metal grid (of another electrode of the same type). For example, the protrusion height (H), which is defined as the height of metal grid 166 protruding past exterior surface 163 of metal layer 161, is at least 1 micrometer or, more specifically, at least 10 micrometers, or even at least 50 micrometers. In some examples, the protrusion is configured to reshape when forming connections to other components.

Referring to FIG. 3E, in some examples, metal grid 166 is stacked with metal layer 161 and additional metal layer 162 with polymer base 170 pushed away from this stack portion (e.g., by removing/displacing a portion of the polymer base 170 before or while forming the stack). Specifically, the metal layer 161 and additional metal layer 162 may directly interface each other. The metal layer 161 may be positioned between the metal grid 166 and the additional metal layer 162.

Referring to FIG. 3F, in some examples, current collector 160 comprises two metal grids 166 such that one metal grid 166 interface with the metal layer 161 while the other metal grid 166 interfaces with the additional metal layer 162. The polymer base 170 may extend in this interface portion of the current collector 160, e.g., as shown in FIG. 3F. Alternatively, at least a part of the polymer base 170 or the entire polymer base 170 may be removed from this interface portion. The two metal grids 166 extend past the stack formed by the polymer base 170 and, in some examples, directly interface with each other.

### Examples of Fabricating Current Collectors

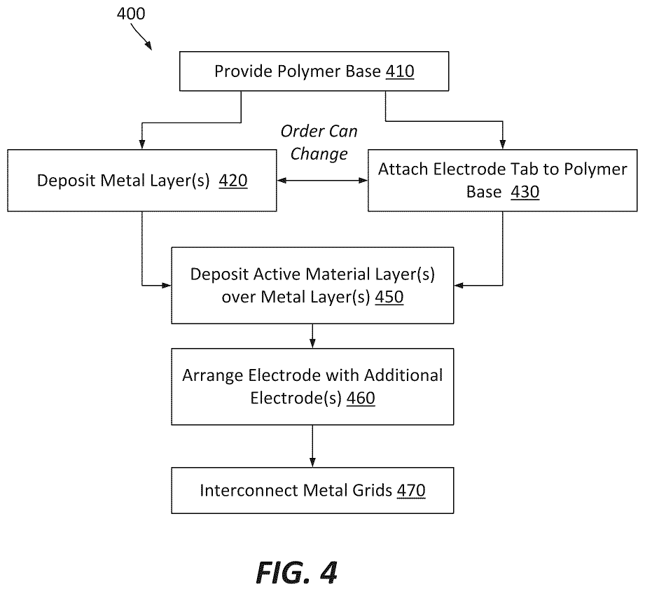

FIG. 4 is a process flowchart corresponding to method 400 of fabricating current collector 160 or, more generally, fabricating electrode 150 comprising current collector 160 or even electrochemical cells 100 comprising current collector 160, in some examples. Various examples of electrochemical cells 100, electrodes 150, and electrochemical cells 100 are described above.

In some examples, method 400 comprises (block 410) providing polymer base 170 comprising first side 171, second side 172, and third side 173. First side 171 is opposite second side 172 and separated from second side 172 by the thickness of polymer base 170. Third side 173 extends between first side 171 and second side 172 along the thickness of polymer base 170.

In some examples, method 400 proceeds with (block 420) depositing metal layer 161 on first side 171 of polymer base 170. Metal layer 161 has a thickness smaller than the thickness of polymer base 170. Various deposition techniques, such as sputtering, are within the scope.

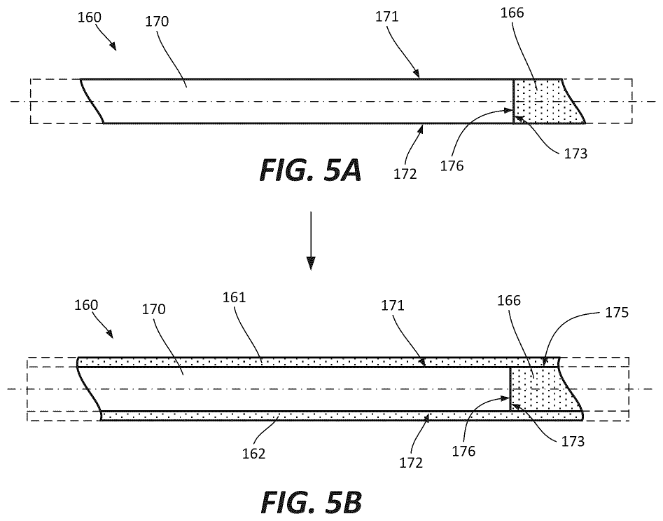

In some examples, method 400 comprises (block 430) attaching metal grid 166 to third side 173 of polymer base 170 thereby forming a polymer base-grid interface 176 with polymer base 170. This grid-attaching operation (block 430) can be performed before or after the metal-layer depositing operation (block 420). For example, FIGS. 5A and 5B illustrate an example where the grid-attaching operation (block 430) is performed before the metal-layer depositing operation (block 420). In either case, when both operations are completed, metal grid 166 is electrically coupled to metal layer 161. In some examples, the grid-attaching operation (block 430) further comprises welding metal grid 166 to metal layer 161.

In some examples, the grid-attaching operation (block 430) comprises at least one of (a) welding metal grid 166 to polymer base 170, (b) adhering metal grid 166 to polymer base 170, (c) inserting a portion of metal grid 166 into polymer base 170, and (d) overlapping a portion of metal layer 161 with metal grid 166.

In some examples, method 400 also comprises (block 450) depositing one or more active material layers over corresponding metal layers of current collector 160, (block 460) arranging electrode 150 (formed with current collector 160) with other electrodes (e.g., staking, winding into a jelly roll), and/or (block 470) interconnecting metal grid 166 with other metal grids and/or other components (e.g., cell tabs)

### Application Examples

Electrochemical cell 100, e.g., lithium-metal cell, described herein, can be used for various applications, such as ground-based vehicles, boats, aircraft, and spacecraft. For example, aircraft and/or spacecraft use Li-metal batteries as such batteries have significantly higher gravimetric energy density than, e.g., Li-ion batteries. Both aircraft and spacecraft applications require lower mass cells, as additional mass leads to lower payload capacity. For these applications to utilize the maximum amount of their designed capacity, the energy system must be the lowest mass possible. In addition, safety is paramount in both of these applications, as onboard fires while in flight could be mission-critical and cause catastrophic failure of the system. In this scenario, occupants or personnel using the system are not able to simply depart from aircraft and/or spacecraft (e.g., in comparison to ground-based vehicles).

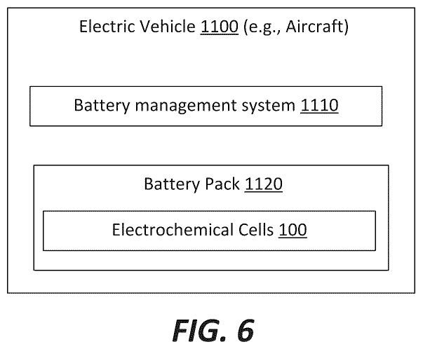

FIG. 6 is a block diagram of electric vehicle 1100 (e.g., aircraft) comprising battery pack 1120, which in turn comprises one or more electrochemical cells 100. Electric vehicle 1100 also comprises battery management system 1110, electrically and communicatively coupled to battery pack 1120. For example, battery management system 1110 can receive various operating signals from battery pack 1120, such as state of charge, temperature, voltage, current, and the like.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. An electrochemical cell comprising:
an electrode comprising a current collector and an active material layer, wherein:
the current collector comprises a polymer base comprising a first side, a second side, and a third side,
the first side is opposite the second side and separated from the second side by a thickness of the polymer base,
the third side extends between the first side and the second side along the thickness of the polymer base,
the current collector further comprises a metal layer disposed on and supported by the first side of the polymer base,
the metal layer has a thickness smaller than the thickness of the polymer base,
the metal layer is positioned between and directly interfaces both the polymer base and the active material layer,
the current collector further comprising a metal grid directly interfacing and supported by the third side of the polymer base thereby forming a polymer base-grid interface with the polymer base, and
the metal grid is electrically coupled to the metal layer and extends away from the active material layer.

2. The electrochemical cell of claim 1, wherein the electrochemical cell is a lithium metal cell.

3. The electrochemical cell of claim 1, wherein:
the electrode is a negative electrode, and
the active material layer is a negative active material layer comprising lithium metal.

4. The electrochemical cell of claim 3, wherein the metal layer comprises one or more lithium, copper, steel, and nickel.

5. The electrochemical cell of claim 1, wherein the composition of the metal layer and the composition of the metal grid is substantially similar.

6. The electrochemical cell of claim 1, wherein the composition of the metal layer and the composition of the metal grid is different.

7. The electrochemical cell of claim 1, wherein:
the metal layer comprises aluminum, and
the metal grid comprises nickel.

8. The electrochemical cell of claim 1, wherein the polymer base comprises polyethylene terephthalate, polypropylene, polycarbonate, polyethylene, polyimide, ceramic-based polymer, cellulose, nylon, and various polyolefins.

9. The electrochemical cell of claim 1, wherein the metal layer and the metal grid form a metal layer-grid interface corresponding to a thickness of the metal layer.

10. The electrochemical cell of claim 9, wherein at least one surface of the metal layer is coplanar with at least one surface of the metal grid.

11. The electrochemical cell of claim 9, wherein the metal layer-grid interface is formed by a weld seam.

12. The electrochemical cell of claim 1, wherein the metal layer extends past the third side of the polymer base and overlaps with the metal grid forming a meta layer-grid interface.

13. The electrochemical cell of claim 1, wherein the meta layer-grid interface extends along at least a portion of a length of the metal grid.

14. The electrochemical cell of claim 1, wherein the meta layer-grid interface forms by sputtering, soldering, or cathodic-arc depositing the metal layer over the metal grid.

15. The electrochemical cell of claim 1, wherein the metal grid protrudes past an exterior surface of the metal layer that faces away from the polymer base.

16. The electrochemical cell of claim 15, wherein a height (H) of the metal grid protruding past the exterior surface of the metal layer is at least 1 micrometer.

17. The electrochemical cell of claim 15, wherein the metal grid is formed by sputtering, soldering, ultrasonic soldering, or electroplating.

18. The electrochemical cell of claim 1, further comprising an additional active material layer, wherein:
the current collector further comprises an additional metal layer disposed on and supported by the second side of the polymer base,
the additional metal layer is positioned between and directly interfaces both the polymer base and the additional active material layer, and
the metal grid is electrically coupled to the additional metal layer and extends away from the additional active material layer.

19. A current collector comprising:
a polymer base comprising a first side, a second side, and a third side, wherein the first side is opposite the second side and separated from the second side by a thickness of the polymer base, and wherein the third side extends between the first side and the second side along the thickness of the polymer base;
a metal layer disposed on, directly interfaces, and supported by the first side of the polymer base, wherein the metal layer has a thickness smaller than the thickness of the polymer base; and
a metal grid directly interfacing and supported by the third side of the polymer base thereby forming a polymer base-grid interface with the polymer base, wherein the metal grid is electrically coupled to the metal layer.

20. A method comprising:
providing a polymer base comprising a first side, a second side, and a third side, wherein the first side is opposite the second side and separated from the second side by a thickness of the polymer base, and wherein the third side extends between the first side and the second side along the thickness of the polymer base,
depositing a metal layer on the first side of the polymer base, wherein the metal layer has a thickness smaller than the thickness of the polymer base; and
attaching a metal grid to the third side of the polymer base thereby forming a polymer base-grid interface with the polymer base, wherein the metal grid is electrically coupled to the metal layer.
